(19) United States
(12) Patent Application Publication
(10) Pub. No.: US 2001/0024038 A1
(43) Pub. Date: Sep. 27, 2001

(54) Pendulum pump

(76) Inventor: Mario Teixeira Cavalheiro, Santos (SP) (BR)

Correspondence Address: NOTARO & MICHALOS P.C., Empire State Building, Suite 6902, 350 Fifth Avenue, New York, NY, 10118-6985, US

(21) Appl. No.: 09/875,640

(22) Filed: Jun. 6, 2001

Related U.S. Application Data
(63) Continuation-in-part of application No. 09/206,874, filed on Dec. 8, 1998.

(30) Foreign Application Priority Data
Jun. 9, 1998 (BR) PI98-2077-3

(51) Int. Cl. H02P 9/04

(52) U.S. Cl. 290/1 R

(57) ABSTRACT

A pumping device has an upright support with a fulcrum at its top. A pendulum beam is pivotally mounted to the fulcrum for pivoting about a horizontal axis. The beam has first and opposite second ends. A U-shaped pipe for containing a liquid such as water, has first and second upturned ends. An overflow pipe and tank and a return pipe and return section receive and hold liquid from the U-shaped pipe. A piston slides in the first end of the U-shaped pipe. The piston is connected to the first end of the pendulum beam for moving up and down with pivoting of the beam. A weight helps force the piston down to push liquid up into the overflow pipe and to the return section. A pair of pivoting, initially spread and weighted wings at the second end of the beam, pivot out to a parallel extended position by the action of a small motor, to increase their effective weight and to thus push down on the second end of the beam for pulling the piston up. Valves allow liquid to return to the U-shaped pipe from the return section. The wings then spread out to reduce their effective weight on the second end of the beam and the cycle repeats.

### CROSS-REFERENCE TO RELATED APPLICATION

The present application is a continuation-in part application of application Ser. No. 09/206,874 filed Dec. 8, 1998 which is incorporated hereby reference.

### FIELD AND BACKGROUND OF THE INVENTION

The present invention relates generally to the field of pumps and in particular to a new and useful pendulum pump.

### SUMMARY OF THE INVENTION

It is an object of the present invention to provide a pumping device for use in pumping water or other liquid. The device has an upright support with a fulcrum at its top. A pendulum beam is pivotally mounted to the fulcrum for pivoting about a horizontal axis. The beam has first and opposite second ends. A U-shaped pipe for containing a liquid such as water, has first and second upturned ends. An overflow pipe and tank and a return pipe and return section receive and hold liquid from the U-shaped pipe. A piston slides in the first end of the U-shaped pipe. The piston is connected to the first end of the pendulum beam for moving up and down with pivoting of the beam. A weight helps force the piston down to push liquid up into the overflow pipe and to the return section. A pair of pivoting, initially spread and weighted wings at the second end of the beam, pivot out to a parallel extended position by the action of a small motor, to increase their effective weight and to thus push down on the second end of the beam for pulling the piston up. Valves allow liquid to return to the U-shaped pipe from the return section. The wings then spread out to reduce their effective weight on the second end of the beam and the cycle repeats.

Water or other liquid from the overflow pipe can run over a turbine in the overflow tank to turn it for amusement. The turbine can also be connected to a generator to generate some electricity for amusement.

Another small motor and reduction gear can be connected to the beam to help pivot it at the fulcrum.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a schematic illustration of the device according to the present invention in a position with waited wings partially spread and a piston in its downward position; and

FIG. 2 is a view similar to FIG. 1 of the device in a second position with the waited wings parallel to each other and the piston being pulled up.

### DESCRIPTION OF THE PREFERRED EMBODIMENTS

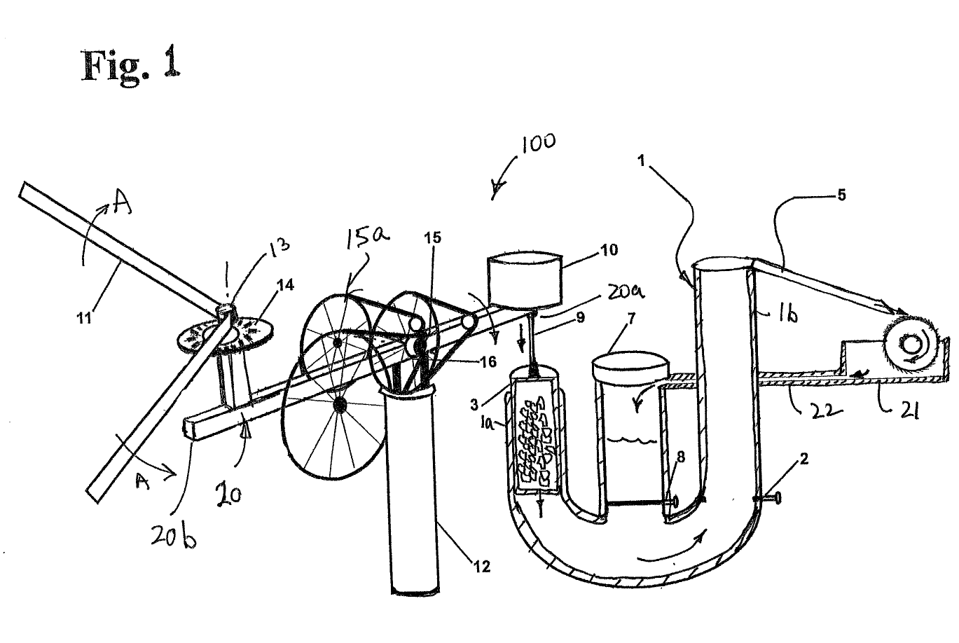

Referring now to the drawings, in which like reference numerals are used to refer to the same or similar elements, FIG. 1 shows a pumping device 100 which has an upright support 12 with a fulcrum 16 at its top end. A pendulum beam 20 is pivotally mounted to the fulcrum for pivoting about a horizontal axis. The beam 20 has a first end 20a and opposite second end 20b. A U-shaped pipe 1 for containing a liquid such as water, has first and second upturned ends la and 1b. An overflow pipe 5 received liquid that has been pushed up end 1b and channels it to an overflow tank 21. During this half-cycle of the device a valve 2 is open while a valve 8 is closed.

A turbine or water-wheel 6 can be provided in tank 21 and rotates when it is supplied with liquid from pipe 5. This rotation can be for amusement or the turbine can be connected to a small generator to generate some electricity, again for amusement. A return pipe 22 return the liquid to a return section 7 which holds liquid above a closed valve 8 from eventual return to the U-shaped pipe 1. A piston 3 slides in the first end 1a of the U-shaped pipe 1. The piston is connected to the first end 20a of the pendulum beam 20 by a rigid rod 9 for moving up and down with pivoting of the beam about its fulcrum 16.

A weight 10 helps force the piston 3 down to push liquid up into the second upright end 1b of pipe 1 and to the overflow pipe 5. The beam 20 is aided in its pivoting by an electric motor 15 which can be powered to pivot the beam 20 in either direction.

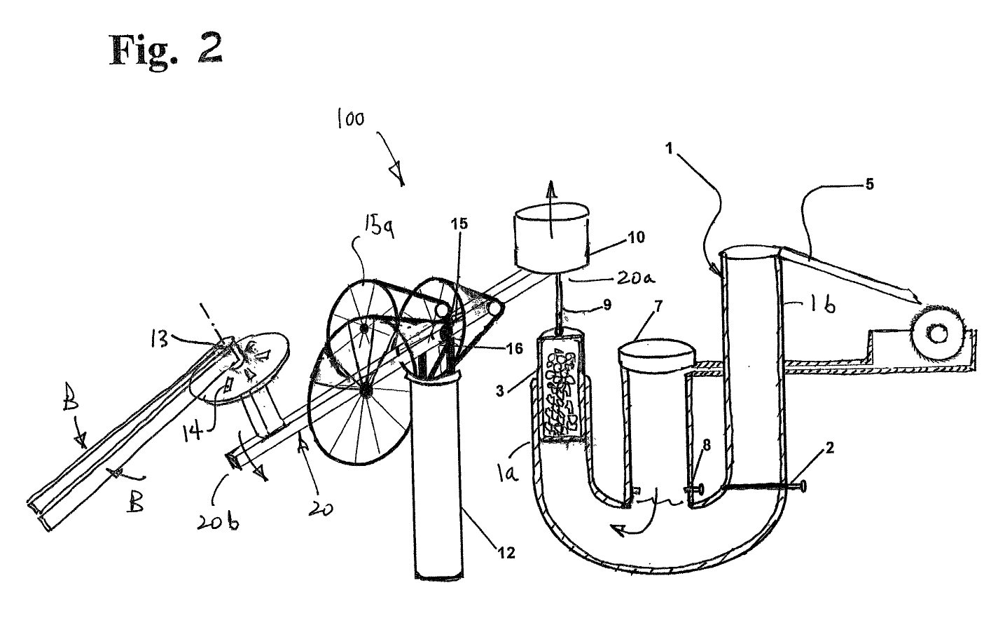

A pair of pivoting, initially spread and weighted wings 11 at pivotally mounted at the second end 20b of beam 20, on a bearing table 14 for helping the wings pivot between an extended parallel position shown in FIG. 2, to a spread position. FIG. 1 shows the wings 11 on their way to the fully spread position, as they pivot in the direction of arrows A under the power of another electric motor 13.

As the wings pivot out to their parallel extended position of FIG. 2, in the direction of arrows B and by the action of the small motor 13, this increases their effective weight at second beam end 20a, and this pushes down on the second end of the beam for pulling the piston 3 up. Motor 15 and a reduction gear in the form of wheels and belts 15a reverse to also help lift the piston 3. Valve 8 is opened to allow liquid to return to the U-shaped pipe 1 from the return section 7 and valve 2 in upright end 1a is closed.

Motors 13 and 15 are then reversed again so that the wings 11 spread out (FIG. 1) to reduce their effective weight on the second end 20b of the beam and the cycle repeats.

The sizes and lengths of the piston and pipes are not to scale in the drawings, but are selected to provide enough liquid and liquid displacement to cause liquid to flow along pipe 5 during each half-cycle of the device.

While a specific embodiment of the invention has been shown and described in detail to illustrate the application of the principles of the invention, it will be understood that the invention may be embodied otherwise without departing from such principles.

What is claimed is:

1. A pumping device comprising:
an upright support with a fulcrum at its top;
a pendulum beam pivotally mounted to the fulcrum for pivoting about a horizontal axis, the beam having a first end and an opposite second end;
a U-shaped pipe for containing a liquid, the U-shaped pipe having a first upturned end and a second upturned end;
an overflow pipe connected to the second upturned end for discharging liquid for the second upturned end;
an overflow tank for receiving liquid from the overflow pipe;
a return section connected to the overflow tank for receiving and hold liquid, the return section being connect to the U-shaped pipe;
valve means for separating the return section from the U-shaped pipe;
a piston slidably mounted in the first upturned end of the U-shaped pipe, the piston being connected to the first end of the pendulum beam for moving up and down with pivoting of the beam;
a weight at the first end of the beam for helping force the piston down to push liquid up into the second upturned end and to the overflow pipe;
a pair of pivoting weighted wings at the second end of the beam, the wings having a spread position for exerting reduced weight at the second end of the beam and a parallel extended position for exerting an increased weight at the second end of the beam, the increased weight of the wings thus pushing down on the second end of the beam for pulling the piston up; and
motor means for pivoting the wings between their parallel and spread positions.

2. A pumping device according to claim 1 or inset valve means includes a first valve in the first of bright end of the U-shaped pipe and a second valve between the return section and the U-shaped pipe.

3. A pumping device according to claim 2 including a turban in the overflow tank for being rotated by liquid from the overflow pipe.

4. A pumping device according to claim 3 including a motor with reduction gear connected to the beam for pivoting the beam at the fulcrum.

5. A pumping device according to claim 1 including bearing means for facilitating pivotable movement of the wings.
